(19) United States
(12) Patent Application Publication
(10) Pub. No.: US 2002/0013743 A1
(43) Pub. Date: Jan. 31, 2002

(54) Automated Purchasing system

(76) Inventor: Edwin Shoffner, Greenville, SC (US)

Correspondence Address: Douglas W. Kim, FLINT & KIM, P.A., P.O. Box 10827, Greenville, SC, 29603, US

(21) Appl. No.: 09/915,052

(22) Filed: Jul. 25, 2001

Related U.S. Application Data
(60) Provisional application No. 60/220,581, filed on Jul. 25, 2000.

(51) Int. Cl. G06F 17/60

(52) U.S. Cl. 705/27; 705/26

(57) ABSTRACT

This invention is directed toward an integrated product evaluation selection and purchasing system allowing the consumer to both physically evaluate a product in the showroom environment as well as to utilize the benefits of online selection and e-commerce purchasing. The showroom environment contains an interactive stand capable receiving product criteria from the consumer representing the desired characteristics of a good. The interactive stand is able to direct the consumer to perform physical evaluations on samples of goods representing the available goods for sale and to include these physical evaluations into the product criteria of the consumer. The interactive stand is then able to compare the product criteria with selection characteristics to provide a hierarchy of preferred goods ordered by preference. The consumer may purchase a good wherefore the purchase information is transmitted to a call center and, ultimately, to a distribution center, where shipping takes place.

This application claims priority pursuant to 35 U.S.C. § 119 of provisional application No. 60/220,581.

### FIELD OF THE INVENTION

This invention is directed to an integrated product evaluation, solution, and purchasing system, particularly to an integrated system eliminating the need for an on-floor-sales-staff and still allowing for product selection and purchases based upon the requirements of the customer, physical evaluation of the product, and characteristics of the product.

### BACKGROUND OF THE INVENTION

Historically, many goods, such as furniture and mattresses in particular, required a purchaser to be assisted by a salesperson to explain the qualities and differences of the good. There is a strong need of a customer to experience the look and feel of a piece of furniture prior to purchasing the item. In particular, a consumer needs to physically evaluate a mattress prior to its purchase. Since the average mattress is used for eight to ten years, it is important that the consumer select a mattress to match the consumer's needs. Frankly, it is difficult to imagine purchasing a mattress having never laid upon it. Unfortunately, sales personnel in the furniture industry tend to push customers toward products that were represented by the sales person or bring the highest commission rather than the best product for the consumer. Nevertheless, it was necessary to utilize a sales person in the showroom environment since the furniture selection relied so heavily on the “touch-and-feel” aspect of the purchase. Therefore, the showroom and sales personnel was necessary for furniture sales.

It is theorized that the demise of customers to “touch-and-feel” furniture prior to purchase which resulted in many returns at great shipping expense. Simply put, customers needed to see and feel the item prior to purchase.

Due to the nature of e-commerce and the furniture purchasing process, the furniture industry has not been able to take advantage of the benefits of e-commerce. The necessity for a consumer to “touch-and-feel” the furniture significantly limits the ability of the furniture retailer to sell its products online. As such, the vast majority of on-line furniture retailers as well as mattress retailers in particular cannot realize the full potential of e-commerce.

Therefore, the need to satisfy the “touch-and-feel” aspect of the furniture selection process while taking advantage of e-commerce is a problem that significant attention need be given. Previous attempts to solve this problem fail to provide an integrated showroom and e-commerce solution without the elimination of showroom samples and a “live” sales force. For example, U.S. Pat. Nos. 5,053,956 and 3,945,467 rely upon a video image and photographs, respectively, of the products without physical samples.

Accordingly, it is an object of this invention to provide for an e-commerce solution for furniture purchasing while also allowing the consumer to physically evaluate the product in the traditional showroom environment.

Another object of this invention is to provide for a furniture shopping experience controlled by the consumer and without the necessity for an in-person sales force.

Another object of the present invention is to provide for a furniture shopping and ordering system which can be in use 24 hours a day, 7 days a week.

Another object is the present invention is to provide for a standardized furniture shopping and ordering system which may be replicated at multiple locations to provide for consistent merchandise display at multiple physical separate locations.

### SUMMARY OF THE INVENTION

The above objectives are accomplished according to the present invention by integrating a showroom floor, physical samples, and automated system for providing automated demonstrations, product selection, and product purchase by a customer of offered goods without the necessity of the physical presence of sales personnel. The assembly contains a showroom floor area and a plurality of samples of goods representing the available goods for sale located within the showroom floor area. The goods include selection criteria for attributing certain characteristics of the goods to objective factors. For example, concerning mattresses, selection criteria can include firmness, pillow top or not, percentage of silk in the mattress covering, and other criteria a customer may consider when purchasing a mattress. Also included is a means for querying a customer to determine the desired product criteria of the customer and a means for receiving the desirable product criteria from the customer to subsequently compare with the selection criteria of the product. It is also advantageous that the results from physical evaluation of at least of one of the samples within the showroom floor can be included in the selection criteria or desired product criteria. Therefore, means for determining the most preferred good for sale from a goods database, desired product criteria, and selection characteristics provide the customer with a product desirable for purchase. The consumer can “touch-and-feel” the physical samples, enter the information into an expert selection system and be provided with a desirable product to be purchased.

In order to entice the consumer to visit the showroom, the system may also include a video attractor for providing advertising to potential customers. Once a selection is made by the customer, the invention can include a means for receiving an order, a means for presenting an amount due to the customer according to the order, a means for receiving shipping information from the customer, a means for receiving payment from the customer, a means for creating order information, and a means for transmitting the order information to a call center for having the order processed and having the purchased good sent to the customer.

Payment can be received by a credit or debit card according to the amount due. A call center can be in communication with the showroom floor and contains a means for receiving order information transmitted from the showroom floor to the call center, a means for generating delivery information containing product information, shipping information, and customer information according to the order information, and a means for transmitting the delivery information to a distribution center to fulfill the order for the purchased good purchased.

A distribution center can be included and contains an inventory of goods offered for sale, an inventory database contained within a distribution center computer readable medium and representing available goods to be sold at the distribution center. The inventory database contains inventory information representing the physical inventory contained within the distribution center. The distribution center can also contain a means for receiving delivery information from the call center, a means for generating a pick list for selecting the good purchased by the customer according to the product information contained within the delivery information, and a means for adjusting the inventory information contained within the inventory database to reflect an adjustment of inventory count of the product sold according to the delivery information.

A call center database can also be contained within the call center as well as a means for receiving an order information request at the call center having an order inquiry ID. A means for retrieving the order information from the call center database according to the order information request order ID can be included with a means for presenting the order status information to the requester according to the order information request.

The system may also include a telephone contained within the showroom floor in communication with the call center so that the customer can orally communicate with the call center for information concerning the goods offered for sale and displayed on the showroom floor or other related information. Additionally, there can be a means for communicating between the showroom floor and the call center, a video camera contained within the showroom floor, a means for receiving a video signal from the video camera, formatting the video signal for transmission, and transmitting the video signal to the call center via a network connection to allow the customer to interact with the call center through real-time video and audio communications.

The above means can be accomplished by an interactive computing device located within the showroom floor area, a showroom computer readable medium included with the interactive computing device, an input device in communication with the showroom computer readable medium, a processor included with the interactive computing device in communication with the showroom computer readable medium, a goods database containing records representing the goods available for sale with records containing product information and selection characteristics associated with the goods, and a set of selection instructions contained within the showroom computer readable medium. The selection instructions provide the functionalities of querying the customer to determine a desirable product criteria of the customer, receiving the desirable product criteria from the customer using the input device, inviting the customer to physically evaluate at least one of the samples of goods, including the results of the physical evaluation into the desirable product criteria if performed by the customer, creating a hierarchy of preferred goods for sale according to the desirable product criteria and the selection characteristics, and presenting the most preferred good for sale from the goods database to the customer so that the customer is provided with the good most suited to the customer according to the physical evaluation, the desirable product criteria, and the selection characteristics.

The system may also include a set of purchasing instructions that perform the tasks of receiving an order for a good selected by the customer via the input device, presenting the amount due to the customer, receiving shipping information from the customer, receiving payment from the customer via the input device, processing the payment information to create order information, and transmitting the order information to a call center for having the order processed and having the purchased good sent to the customer. The input device can be a touch screen, keyboard, mouse, card-reader, microphone, or any number of devices known to the computer industry.

The system may also include a call center server having a call center processor and a call center computer readable medium, a call center network connection in communication with the showroom computer readable medium and the call center computer readable medium, and a set of call center instructions embodied in the call center computer readable medium. The call center instructions, when processed by the call center processor, perform the tasks of receiving order information transmitted by the purchasing instructions via the call center network connection, generating delivery information containing product information, shipping information, and customer information according to the order information, transmitting the delivery information to a distribution center to allow the distribution center to fulfill the order for a purchased good made by the customer.

The system may also include a distribution center, an inventory of goods offered for sale contained within the distribution center, a distribution center server included within the distribution center and having a distribution center processor and distribution center computer readable medium, an inventory database embodied in the distribution center computer readable medium representing the available goods located at the distribution center, a distribution center network connection in communication with the call center computer readable medium and the distribution center computer readable medium, and a set of computer readable distribution instructions. The distribution instructions, when executed by the distribution center processor, perform the tasks of receiving delivery information via the distribution network connection, generating a pick list for selecting the good purchased by the customer according to the product information contained within the deliver information, and adjusting the inventory information contained within the inventory database to reflect and adjustment of the inventory count of the product sold according to the delivery information.

The system may also include a call center database embodied in the call center computer readable medium representing order status information, order information and the delivery information, and a set of status instructions embodied within the call center computer readable medium. The status instructions, when processed by the call center processor, perform the tasks of receiving an order information request via the call center network connection having an order inquiry ID, retrieving the order information from the call center database according to the order information request order ID, and presenting the order status information to the requestor via the call center network connection.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 is a front view of a showroom;

FIG. 2 is a perspective view of a showroom;

FIG. 3 is a diagram of the various physical locations of the system;

FIG. 4 is a diagram of the interactive stand's various components and connects to a call center and distribution center according to the invention;

FIG. 5 is a flowchart of the consumer's interaction with the system; and,

FIG. 6 is a screen shot of the interactive stand options according to the invention;

FIG. 7 is a flowchart of the interactive stand;

FIG. 8 is a flowchart of the call center according to the invention; and,

FIG. 9 is a flowchart of the distribution center according to the invention.

### DESCRIPTION OF A PREFERRED EMBODIMENT

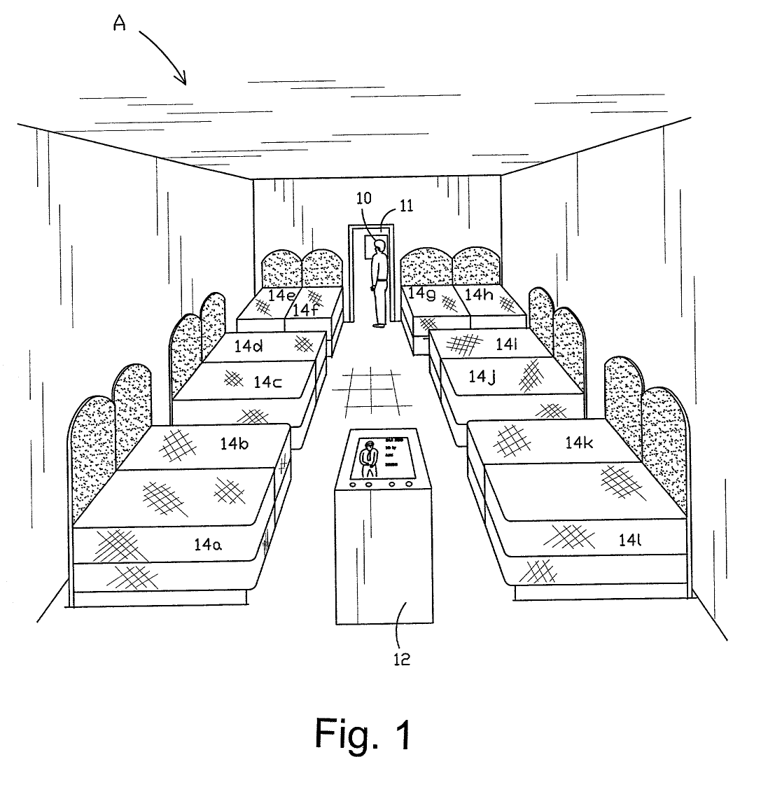

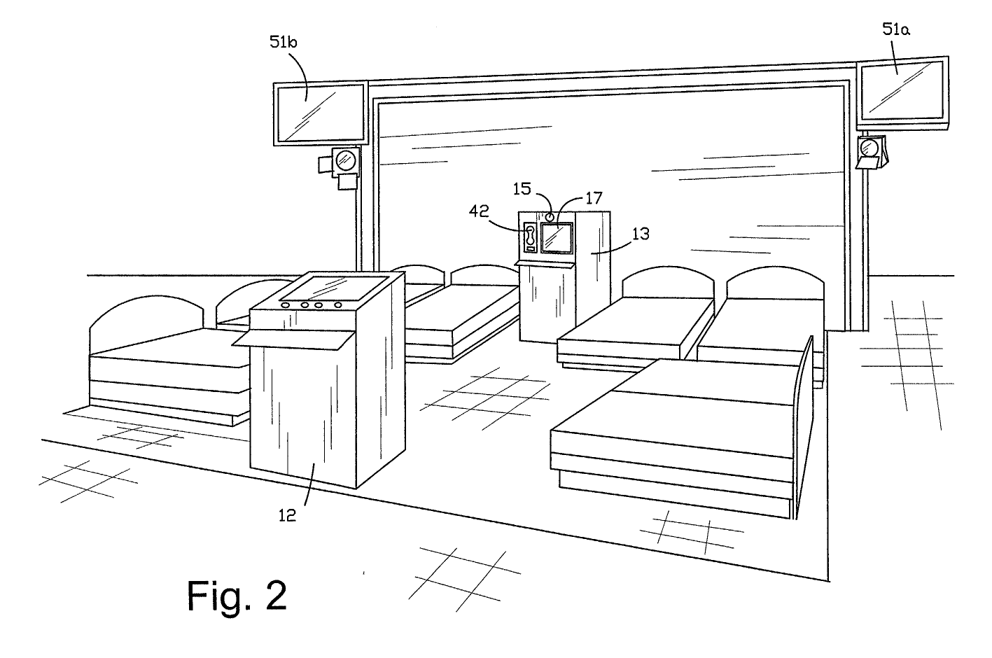

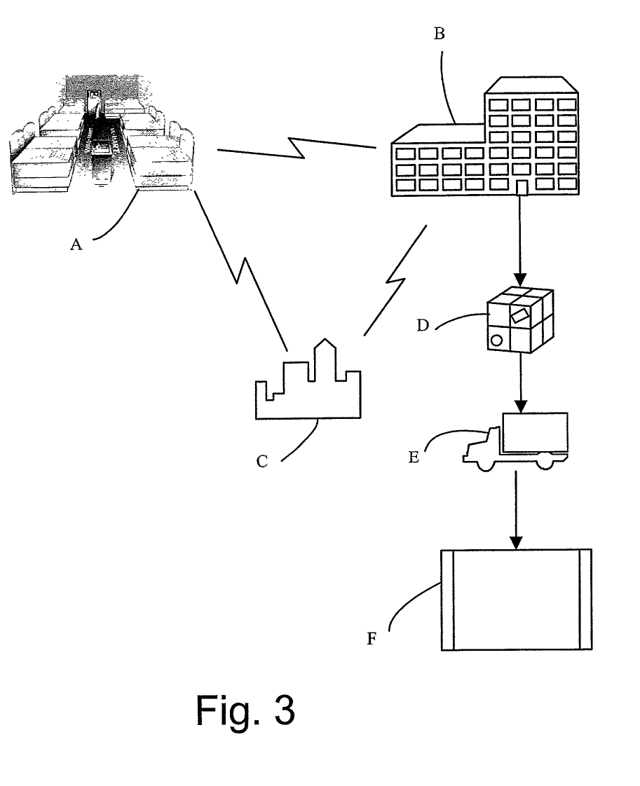

Referring to the drawings, the invention will now be described in more detail. FIG. 1 represents the standardized showroom or showroom floor area A. Contained within the showroom is an interactive stand 12 also known as an interactive computing device or call center server, a video attractor 10 and sample mattresses 14a through 14l representing the available goods for sale. FIG. 2 further illustrates another embodiment where interactive stand 12 can be placed in the front of the showroom floor area and video attractors 51a and 51b are located at the rear of the showroom floor area. A hot-line stand 13 can be included within the showroom area and can include a video camera 15, telephone 42, and a display 17. The video camera 15 may include a microphone for allowing audio, visual, or audio/visual communication with a call center or remotely located sales support with a salesperson rather than conduct product selection and purchase individually. FIG. 3 illustrates showroom A being connected to distribution center B and/or a call center C. Such connection can be through phone lines, Internet, WAN, LAN, Intranet, wireless network, satellite or some other communication means so that data including voice, binary, computer or other information can be transmitted between the showroom call center and distribution center.

Also included within the showroom is a hot-line booth containing a direct communication line from the showroom to the call center. The case may arise when the interactive system is unable to fully answer a consumer's questions, the consumer is more conformable giving billing information to a person rather than a computer, or the consumer merely wishes to speak with another person. Therefore, the consumer merely picks up a phone 42 of FIG. 2 and is immediately connected with call center personnel of call center C of FIG. 3. At this point, all the information contained in the interactive stand can be provided to the consumer, but by call center personnel.

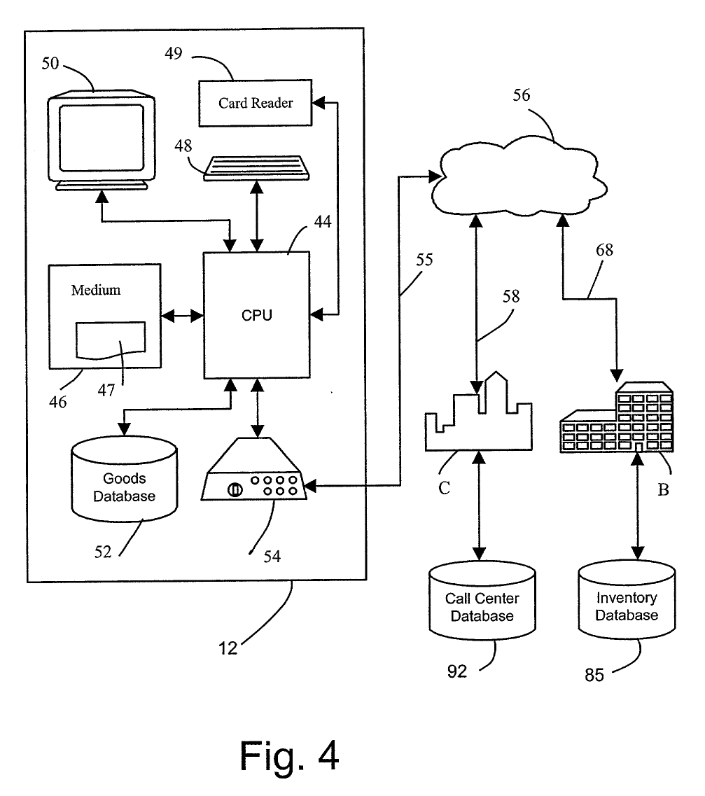

Referring now to FIG. 4, the interactive stand 12 consists of a CRT, LED, plasma or other display 50, known by those skilled in the art, for displaying graphical and textual information to a consumer from a set of computer readable instructions or other electronic media. A computer processor 44 is included in the interactive stand in communication with a computer readable medium 46 that contains computer readable code 47 in the form of a set of computer readable instructions. The program has a network connection 55 or other communication means for connecting with distribution center B or call center C so that information entered at the interactive stand can be transmitted to the distribution center or call center through a WAN 56 such as the Internet. Input means such as a keyboard 48, a touch screen 50, or a card reader 49 can be connected to computer processor 44. Display 50 also provides visual output to the consumer. A goods database 52 for storing information concerning the goods for sale, as well as information entered by the consumer, is also provided. The telephone, microphone, and video camera can utilize communication means 55 or have separate communication paths. It is advantageous to have the audio and video communications trigger transmission of the information concerning the consumer contained within goods database 52 to the call center so that when the consumer is in communication with the call center, the call center is provided the entered information and the consumer does not have to provide this information a second time. FIG. 4 further shows a call center database 92 that can be updated by the call center C and can transmit data back to call center C. FIG. 4 also shows an inventory database 85 that can be updated by the distribution center B and can transmit data back to distribution center B.

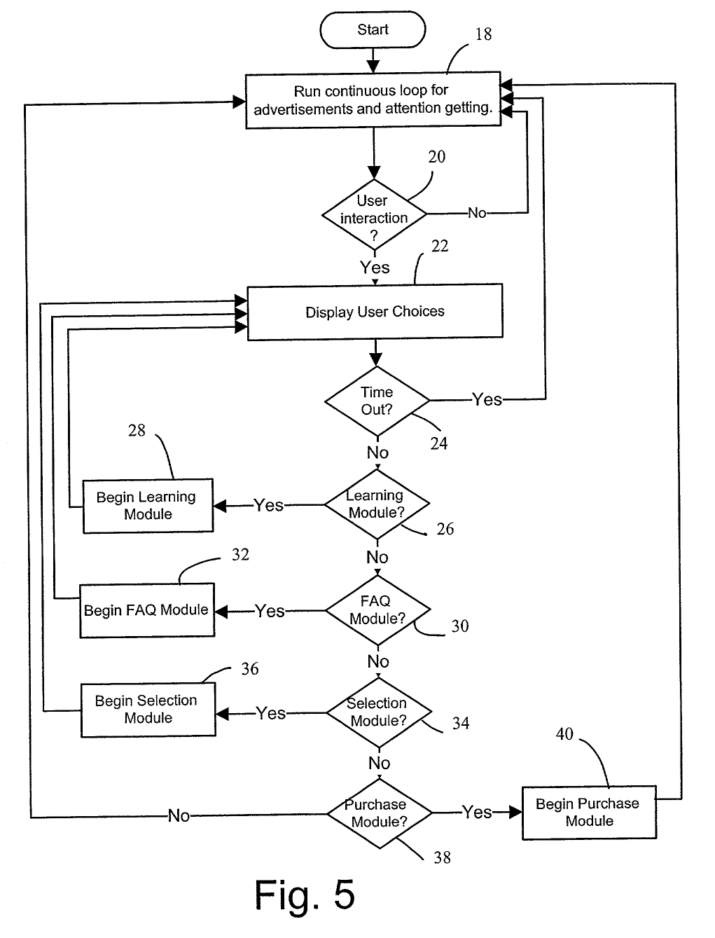

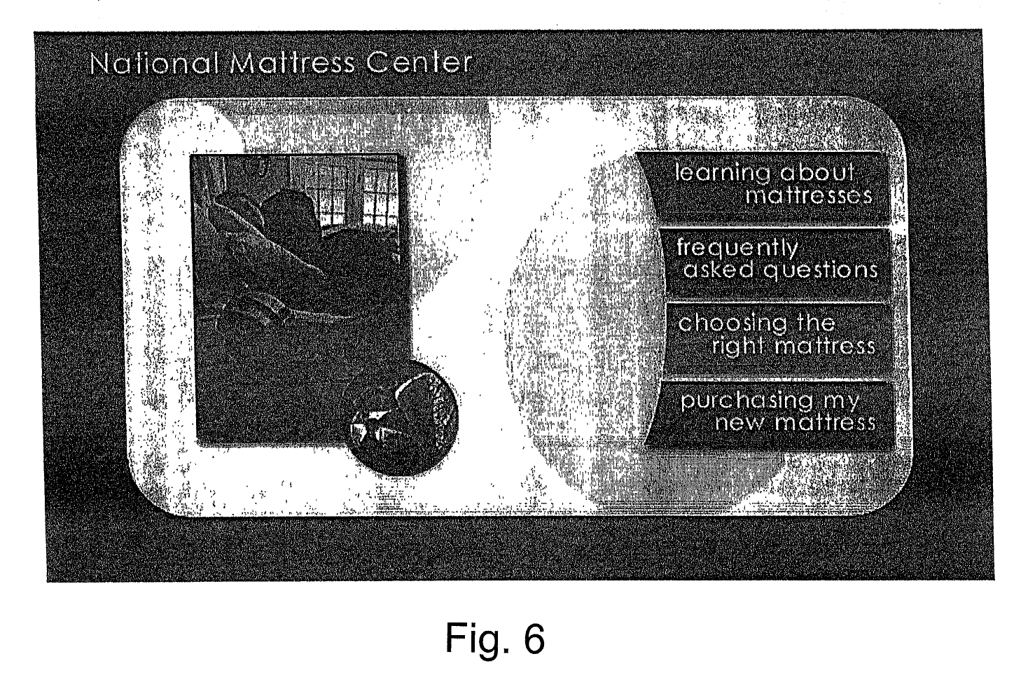

FIG. 5 illustrates the basic flow of the information and actions of the consumer when the consumer uses the interactive stand for selection of a mattress. Initially, the showroom program runs a continuous loop containing advertising, marketing, educational, or other informational material concerning mattresses at step 18. This information can also be viewed on a presentation screen, video attractors, or additional monitors based upon the display configuration of a showroom. When the consumer requests that a selection session begin, the continuous loop is replaced with a display from the computer residing within the interactive stand and the consumer is guided through certain questions. For example, in step 20, the consumer may touch a touch screen of the interactive display informing the computer program that an interactive session should be started. When a consumer interaction is detected, the consumer is provided options for which functions to begin next. For example, step 22 displays four possible functions that are incorporated in the computer program residing on the interactive stand. FIG. 6 illustrates one possible rendition of the option screen displayed to the consumer and includes the options of learning about mattresses, viewing frequently asked questions, choosing the right mattress, and purchasing a new mattress. Referring back to FIG. 5, if none of the functions are selected and the computer program times out in step 24, then the continuous loop of step 18 begins again. If the consumer selects the learning module at step 26, the learning module is started in step 28. Once the learning module is completed, the consumer is returned to the display of choices at step 22.

Concerning the learning module of step 28, the information is provided to the consumer in an interactive manner so that the consumer can direct the type and presentation mode of the information the consumer is requesting. For example, the consumer may wish to be educated concerning the firmness or plushness of a mattress. Therefore, the consumer needs only request this information from a menu generated by the learning module and organized by subject matter. This organization provides the information that the consumer requests and not the information that the traditional mattress sales force wishes to convey.

If the consumer selects the frequently asked questions (FAQ) module at step 30, the FAQ module is started at step 32. The FAQ module is a listing of frequently asked questions designed to assist the consumer with potential questions the consumer may have concerning the mattress selection, manufacturing, billing, or distribution methods associated with this invention. For example, questions which may exist under this module include, but are not limited to:

“Should I have a firm of soft bed?”

“How often should I turn my mattress?”

“How long should a mattress last?”

“Does sleeping position determine which mattress I should purchase?”

“What is a pillow top?”

“What sheets should I buy for this mattress?”

“How long is the warranty?”

“What if the mattress arrives damaged?”

“Will you take my old mattress?”

“What size bed should I buy?”

Organizing such questions can assist the consumer in receiving useful information about the products in general or about specific products.

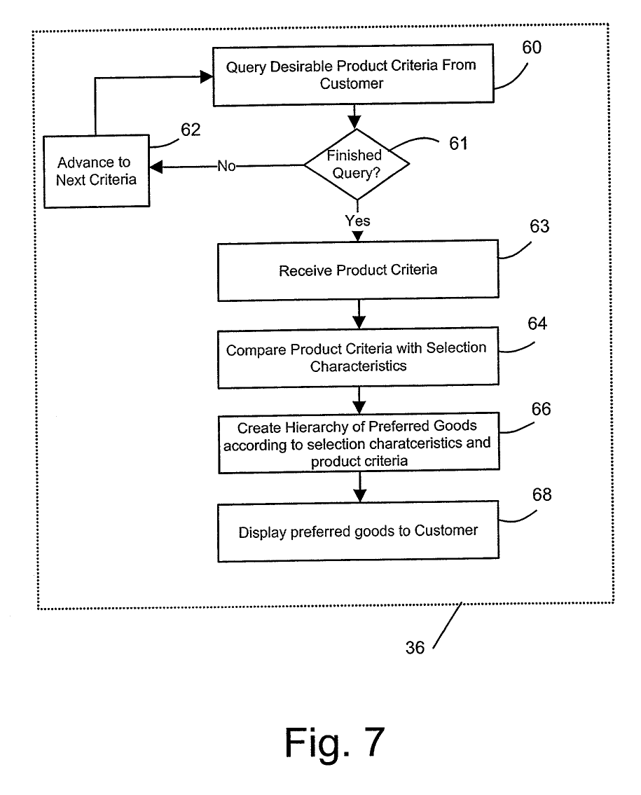

If the consumer selects the mattress selection modules at step 34, the mattress selection module is started at step 36. The selection module of step 36 of FIG. 5 is shown in more detail in FIG. 7. Referring now to FIG. 7, the selection module includes computer readable instructions embodied in a computer readable medium included with the showroom area which, once activated by the consumer, the selection module queries the consumer for the desired product criteria at step 60. By asking and receiving answers to several inquires, the selection module can offer suggestions to the consumer concerning the recommended mattress for that consumer's needs. For example, if the mattress is for a guest bed rather than a primary bed, this fact would influence the decision as to the most preferred mattress. Whether the user prefers a firm or soft mattress would also effect the decision. Additional factors include whether the consumer wants a plush top, pillow top or flat top on the mattress. Further criteria include price range, size, brand, and other such factors. Many of these criteria are best determined by the customer by physical evaluation of product samples located on the showroom floor. For example, whether a customer prefers a firm or soft mattress may only be determined upon laying upon both a firm and a soft mattress, and comparing the feel of the two. Therefore, the customer can be invited to lay on mattress 14a (FIG. 1) which would have a firm feel and then lay on 14b (FIG. 1) which would be the identical mattress except with a soft feel. Upon performing this physical evaluation, the customer can determine which of the two feels is preferential. The same is true for the type of topping placed upon the mattress. For example, 14c (FIG. 1) may be a pillow top while 14d (FIG. 1) may be a flat top. Upon performing a physical evaluation of these two samples, the customer can more readily decide which of the characteristics of the mattress are preferred and include those in the product criteria they enter. Therefore, this invention allows the integration of an online ordering product selection system while also providing showroom samples to be physically evaluated by the customer.

At step 61, the selection module checks to see if it is finished with the query. If it is finished, it continues to step 63 where the product criteria is received. If it is not finished, then it advances to the next criteria at step 62, then back to querying for potential product criteria at step 60. Upon receiving these criteria, the selection module can then compare the product criteria with the selection characteristics of the products available for sale in step 64. The goods database 52 (FIG. 4) contains the goods available for sale as well as the characteristics of those particular goods. For example, the mattress represented by sample 14a (FIG. 1) may have characteristics such as firm and pillow top. If the product criteria received by the consumer matches firm and pillow top then the good represented by sample 14a (FIG. 1) would be a preferred choice for the consumer. The same is true for other criteria such as size, price, and purpose. By evaluating the product criteria and the selection characteristics, the selection module can create a hierarchy of preferred goods according to the characteristics and criteria in step 66 and presents the preferred goods to the customer in step 68. It should be noted that the customer can be presented with either the best match, equivalent matches, or a list of matches for the consumer to then further evaluate.

Referring back to FIG. 5, if the consumer decides to purchase a mattress at step 38, the purchase module is started at step 40 and the consumer is returned to the continuous loop of step 18 when the purchase process is completed.

Once a selection is made, the purchase module of step 40 allows the consumer to actually make the purchase. The customer can enter an order including billing information and payment information. The purchase module can retrieve the pricing of the selected good so that the consumer can actually enter payment through such means as a credit card or debit card. Additionally, the consumer can contact the call center and tell the call center personnel the credit card information if the consumer is uncomfortable with entering the payment information online. The purchase module the formats the information into an order record. The order record is then transmitted to the call center.

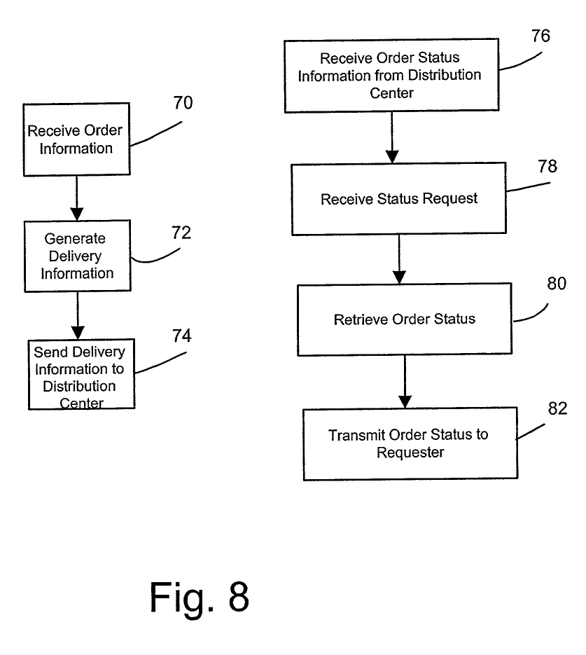

Referring to FIG. 8, call center C's processes are described in more detail. Since the call center is connected to the showroom through connection 58 (FIG. 4), the consumer can interact with the call center personnel to gain assistance from the call center via audio or video conferencing. Through such communication, the consumer can ask questions concerning firmness and the call center can ask the consumer to lay on several of the mattresses to assist the consumer in making a mattress selection based on this criteria. Since each showroom is standardized, the call center is able to direct the consumer to the products on display and both consumer and call center personnel have the same reference point.

The call center server can also be contacted directly by the interactive display stand. When the user enters information into the interactive display stand 12 (FIG. 1) in the showroom A (FIG. 1) the call center instructions embodied in the call center computer readable medium, when executed by a call center processor, allow the call center server to receive the information in the order record format through a connection 58 (FIG. 4) at step 70. The call center server can then generate delivery information at step 72 based on the order record. That delivery information is transmitted to the distribution center D through means of communication 66 (FIG. 4) at step 74.

The call center also has a call center database 92 (FIG. 4) containing order information that can be updated by the interactive stand or the distribution center in step 76. Often times, consumers will call with questions about their order status. The call center has capabilities of obtaining answers to these questions through the call center database 92 (FIG. 4). The call center is kept updated by receiving information from the distribution center in step 76. When the call center database receives a status request at step 78, the call center server can retrieve the order status from the call center database 92 (FIG. 4) at step 80, and transmit the information from the call center database 92 (FIG. 4) to the requester at step 82.

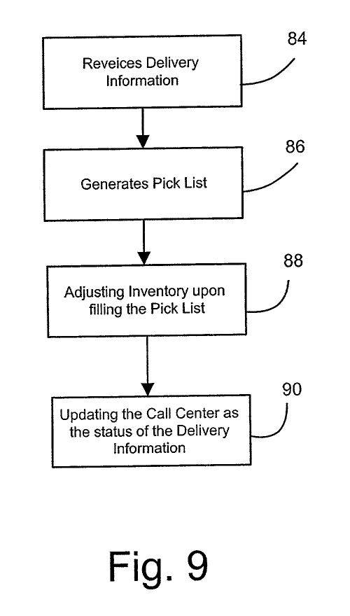

Referring now to FIG. 9, the distribution center's processes are described in more detail. The distribution center is where the actual physical inventory of goods offered for sale resides. By having the distribution center server connected to the call center through network connection 68 (FIG. 4), the distribution instructions embodied in the distribution center computer readable medium, when executed by the distribution center processor, allow the distribution center server to receive delivery information from the call center through means of communication 56 (FIG. 4) at step 84. Upon receiving the delivery information, the pick list is generated in step 86. The pick list is used to uphold the actual good purchase from the physical inventory at the distribution center and for shipment out to the purchasing customer. Once the pick list has been filled, the inventory is adjusted of an inventory database 85 (FIG. 4) located at the distribution center to reflect that fact that the pick list has been filled at step 88. Once the selected product has been shipped to the customer, the call center is notified with this information so that the call center can update the order status database contained at the call center at step 90.

Referring back to FIG. 3, the process of finalizing an order is shown. The distribution center B, once the good has been selected and the database updated, sends the order D through transportation means E to its final destination F. The information for final destination F is the same information that the customer originally entered during the shipping information module.

The computer readable instructions of the interactive stand also has the ability to record the interaction of the consumer when using the system. For example, the consumer using the system may be primarily concerned with price when shopping for a mattress and this would be reflected with criteria entered by the consumer into the selection modules, purchasing modules or FAQ modules. The amount of like information about the consumer base that can be collected is vast and capturing this interactive information has tremendous value. Since each showroom will be at a known location, the buying habits and information requests of a consumer can also be categorized by geographic location for later analysis. Examples of such information which can be collected include, but is not limited to:

Name and address.

Mattress requirements and criteria.

Length of time shopping for a mattress.

Type of mattress purchased.

Average price range requested for a mattress.

Obviously, such information is invaluable concerning the mattress consumer.

Since the online system is accessible through such communications means as the Internet or telephone networks, the consumer does not necessarily have to access the call center or distribution centers from the showroom. The consumer can utilize the Internet or traditional telephone networks to request information, place an order or provide billing information. The benefit is that the consumer has a showroom in which to visit and can touch and feel the product prior to ordering a new mattress.

Numerous characteristics and advantages of the invention have been set forth in the foregoing description, together with details of the structure and function of the invention, and the novel features thereof are pointed out in appended claims. The disclosure, however, is illustrative only, and changes may be made in detail, especially in matters of shape, size and arrangement of parts, within the principle of the invention, to the full extent indicated by the broad general meaning of the terms in which the appended claims are expressed.

What is claimed is:

1. An integrated, interactive display, sales, and delivery system allowing for automated demonstrations, product selections, and purchases by a customer of offered goods without the necessity of the physical presence of sales personnel comprising:
a showroom floor area;
a plurality of samples of goods representing the available goods for sale located within said showroom floor area, said samples having selection characteristics;
an interactive computing device located within said showroom floor area;
a showroom computer readable medium included with said interactive computing device;
an input device in communication with said showroom computer readable medium;
a processor included with said interactive computing device in communication with said showroom computer readable medium;
a goods database containing records representing said goods available for sale, product information, association information associating at least one good available for sale with at least one of said samples of goods located within said showroom floor area, and selection characteristics associated with said goods; and
a set of selection instructions contained within said showroom computer readable medium for, when executed by said processor, performing the tasks of querying the customer to determine a desirable product criteria of the customer, receiving said desirable product criteria from the customer via said input device, inviting the customer to physically evaluate at least one of said samples of goods, including a result of the physical evaluation into the desirable product criteria if performed by the customer, creating a hierarchy of preferred goods for sale according to said desirable product criteria and said selection characteristics, and presenting the most preferred good for sale from said goods database to the customer so that the customer is provided with the good most suited to the customer according to the physical evaluation, the desirable product criteria, and the selection characteristics.

2. The system of claim 1 including a video attractor for providing advertising material to potential customers of the goods offered for sale represented by said samples on said showroom floor.

3. The system of claim 1 including:
a set of purchasing instruction embodied in said computer readable medium for, when executed by said processor, performing the tasks of receiving an order for the most desirable good presented to the customer via said input device containing product information, presenting the amount due to the customer, receiving shipping information from the customer, receiving customer information from the customer, receiving payment from the customer via said input device, processing the payment information to create an order record, and transmitting the order record to a call center for having the order record processed and having the purchased good sent to the customer.

4. The system of claim 3 including a card reader for receiving payment information from the customer according to said amount due presented to the customer.

5. The system of claim 3 including:
a call center server having a call center processor and a call center computer readable medium;
a call center network connection in communication with said showroom computer readable medium and said call center computer readable medium; and,
a set of call center instructions embodied in said call center computer readable medium that, when processed by said call center processor, performs the tasks of receiving the order record transmitted by said purchasing instructions via said call center network connection, generating delivery information containing product information, shipping information, and customer information according to said order record, transmitting said delivery information to a distribution center to allow the distribution center to fulfill the order for a purchased good desired by the customer.

6. The system of claim 5 including:
a distribution center;
a physical inventory of goods offered for sale contained within said distribution center;
a distribution center server included within said distribution center and having a distribution center processor and distribution center computer readable medium;
an inventory database embodied in said distribution center computer readable medium representing the available goods to be sold located at said distribution center, said inventory database containing inventory information representing the physical inventory contained within said distribution center;
a distribution center network connection in communication with said call center computer readable medium and said distribution center computer readable medium; and,
a set of distribution instructions embodied in said distribution center computer readable medium that, when executed by said distribution center processor, performs the tasks of receiving delivery information via said distribution network connection, generating a pick list for selecting at least one good purchased by the customer according to said product information contained within said deliver information, adjusting said inventory information contained within said inventory database to reflect and adjustment of the inventory count of the product sold according to said delivery information.

7. The system of claim 5 including:
a call center database embodied in said call center computer readable medium representing order status information and order information and said delivery information; and,
a set of status instructions embodied within said call center computer readable medium that, when processed by said call center processor, performs the task of receiving an order information request via said call center network connection having an order inquiry ID, retrieving said order information from said call center database according to said order information request order ID, and presenting said order status information to the requester via said call center network connection so the order status requester can be apprised as to the progress of filling an order.

8. The system of claim 1 including a telephone contained within said showroom floor in communication with a call center so that the customer can orally communicate with the call center concerning the goods offered for sale, displayed on said showroom floor, or ordered.

9. The system of claim 8 including:
a network connection in communication with said showroom computer readable medium and the call center;
a video camera contained within said showroom floor and connected to said network connection;
a set of communications instructions embodied in said computer readable medium for receiving a video signal from said video camera, formatting said video signal for transmission; and, transmitting said video signal to the call center via said network connection allowing the customer to interact with the call center through real-time video and audio communications allowing the tasks performed by the customer to be directed by personnel at said call center.

10. An integrated, interactive display, sales, and delivery system allowing for automated demonstrations, product selections, and purchases by a customer of offered goods without the necessity of the physical presence of sales personnel comprising:
a showroom floor area;
a plurality of samples of goods representing the available goods for sale located within said showroom floor area, said goods having selection characteristics;
an interactive computing device located within said showroom floor area;
a goods database having goods information representing goods for sale associated with said plurality of samples;
a means for querying a customer to determine the desired product criteria of the customer;
a means for receiving said desirable product criteria from the customer by said interactive computing device, said desirable product criteria having results from physical evaluation of at least of one of said samples of goods within said showroom floor area; and
a means for determining the most preferred good for sale according to said goods database, desired product criteria of the customer, and the selection characteristics of the goods for sale.

11. The system of claim 10 including a video attractor for providing advertising material to potential customers with the goods offered for sale represented by said samples on said showroom floor.

12. The system of claim 10 including:
a means for receiving customer information by said interactive computing device;
a means for receiving an order for the good presented to the customer by said interactive computing device containing product information;
a means for presenting an amount due to the customer according to the order received from the customer;
a means for receiving shipping information from the customer interactive computing device;
a means for receiving payment from the customer by said interactive computing device in response to presenting the amount due to the customer according to the order received from the customer;
a means for creating an order record according to receiving payment from the customer; and
a means for transmitting the order record to a remote location for having the order processed and having the purchased good sent to the customer.

13. The system of claim 12 including a means for receiving payment by a credit or debit card according to said amount due presented to the customer.

14. The system of claim 12 including a call center in communication with said showroom floor;
a means for receiving order information transmitted from said showroom floor to said call center;
a means for generating delivery information containing product information, shipping information, and customer information according to said order information; and
a means for transmitting said delivery information to a distribution center to fulfill the order for the purchased good purchased by the customer.

15. The system of claim 14 including:
a distribution center;
a distribution center server;
a physical inventory of goods offered for sale contained within said distribution center;
an inventory database included at said distribution center and representing available goods for sale at said distribution center, said inventory database containing inventory information representing the physical inventory contained within said distribution center;
a means for receiving delivery information from said call center by said distribution server;
a means for generating a pick list by said distribution server for selecting the good purchased by the customer according to said product information contained within said delivery information; and
a means for adjusting said inventory information contained within said inventory database to reflect an adjustment of inventory count of the product sold according to said delivery information.

16. The system of claim 15 including:
an call center database contained within said call center server;
a means for receiving an order information request by said call center server having an order inquiry ID;
a means for retrieving said order information from said call center database according to said order information request order ID; and
a means for presenting said order status information to the requestor according to said order information request so that the requester knows the status of the associated order.

17. The system of claim 10 including a telephone contained within said showroom floor in communication with a call center so that the customer can orally communicate with the call center for information concerning the goods offered for sale and displayed on said showroom floor.

18. The system of claim 17 including:
a means for communicating between said showroom floor and said call center;
a video camera contained within said showroom floor;
a means for receiving a video signal from said video camera, formatting said video signal for transmission, and transmitting said video signal to the call center via said means for communication allowing the customer to interact with the call center through real-time video and audio communications.

19. A method for purchasing goods from samples located on a showroom floor having a plurality of samples representing the goods offered for sale and a interactive demonstration, and purchase system comprising the steps of:
entering the showroom;
engaging an interactive display having a computer readable medium containing computer readable instructions for selecting and purchasing a good, the good having selection characteristics;
entering information about preferences to said interactive display responsive to said set of computer readable instructions;
physically evaluating at least one of the samples of goods;
entering the results of the physical evaluation into the interactive display responsive to said set of computer readable instructions;
viewing a list of displayed goods displayed according to said selection characteristics of the goods on display, preferences of the customer, and physical evaluation performed by the customer;
selecting a good for purchase from the list of goods displayed;
viewing the amount due according to the good selected; and
entering shipping information so that the good selected can be shipped to the customer.

20. The method of claim 19 including the step of interacting with a call center concerning the selection of a good for sale so that a customer may communicate with a remotely located sales personnel.
